(19) United States
(12) Patent Application Publication
(10) Pub. No.: US 2013/0250566 A1
(43) Pub. Date: Sep. 26, 2013

(54) LIGHTING DEVICE AND LIGHTING FIXTURE

(71) Applicant: TOSHIBA LIGHTING & TECHNOLOGY CORPORATION, Kanagawa (JP)

(72) Inventor: Mitsuhiko NISHIIE, Kanagawa (JP)

(73) Assignee: Toshiba Lighting & Technology Corporation, Kanagawa (JP)

(21) Appl. No.: 13/790,349

(22) Filed: Mar. 8, 2013

(30) Foreign Application Priority Data
Mar. 23, 2012 (JP) 2012-066879

(51) Int. Cl. F21V 13/02; F21V 29/00; F21V 29/02; F21V 1/14

(52) U.S. Cl. CPC F21V 13/02; F21V 1/14; F21V 29/2206; F21V 29/2275; F21V 29/02
USPC 362/218; 362/217.02; 362/217.05

(57) ABSTRACT

A lighting device includes a cover member and a light source body. The cover member is configured to have a tubular shape and at least partially has a light transmitting portion. The light source body includes a plate-shaped and flexible substrate. The substrate is inserted into the cover member along a longitudinal direction of the cover member. A plurality of solid state light emitting elements are disposed on one surface side of the substrate. A cross-sectional shape in a lateral direction of the substrate is along an inner surface of the cover member. In addition, the substrate is configured in such a manner that, on the vertical line where the plurality of solid state light emitting elements are positioned respectively, a distance between each of the adjacent solid state light emitting elements and the inner surface of the light transmitting portion is different from each other.

### CROSS-REFERENCE TO RELATED APPLICATION

This application is based on Japanese Patent Application No. 2012-66879, filed on Mar. 23, 2012, the content of which is incorporated herein by reference.

### FIELD

Embodiments described herein relate generally to a lighting device using a solid state light emitting element such as a light emitting diode as a light source, and to a lighting fixture using the lighting device.

### BACKGROUND

Recently, as a substitution for a filament bulb, a straight tubular lighting device is proposed using a light emitting diode (hereinafter referred to as an “LED”) which is a solid state light emitting element with a long-term durability and a low power consumption as a light source.

The straight tubular lighting device is generally configured by a cylindrical cover member and a substrate. As a substrate, a hard substrate such as a planar paper phenol or a glass epoxy is used, where LEDs are disposed on one side thereof. Then the substrate is inserted into the cylindrical cover member. As a result, light from the LEDs is emitted from one surface side of the planar substrate and may not be emitted to the rear surface side.

Therefore, when the straight tubular lighting device is assembled in a ceiling-mounted lighting fixture or the like, light is mainly emitted directly downward from the lighting fixture in combination with the characteristics of the LEDs of a strong light directivity. Therefore, since different illumination is provided compared to a fluorescent lamp, a user who is accustomed to a traditional light source, may feel a discomfort. Therefore, in the straight tubular lighting device using such a type of LEDs as a light source, a challenge is to widely perform a light distribution control.

### DESCRIPTION OF THE DRAWINGS

FIG. 1A is an exploded perspective view of a lighting device according to a first embodiment.

FIG. 1B is an end view illustrating the lighting device in a state where a cap member is removed.

FIG. 2A is a cross-sectional view of a left end portion of the lighting device.

FIG. 2B is a perspective view illustrating a state where a light source body of the lighting device is inserted into a cover member.

FIG. 3 is a diagram to explain steps for assembling the light source body of the lighting device.

FIG. 4A is a front view of a lighting fixture on which the lighting device is mounted.

FIG. 4B is a side view of the lighting fixture to which the lighting device is mounted.

FIG. 5A is an end view illustrating the lighting device in a state where the cap member is removed according to a second embodiment.

FIG. 5B is an end view illustrating a light emitting direction of the lighting device according to the second embodiment.

FIG. 6A is an end view illustrating the lighting device in a state where the cap member is removed according to a third embodiment.

FIG. 6B is an end view illustrating a light emitting direction of the lighting device according to the third embodiment.

FIG. 7A is an end view illustrating the lighting device in a state where the cap member is removed according to a fourth embodiment.

FIG. 7B is an end view illustrating a light emitting direction of the lighting device according to the fourth embodiment.

FIG. 8A is an end view illustrating a modification example of the lighting device according to the fourth embodiment in a state where the cap member is removed.

FIG. 8B is an end view illustrating the light emitting direction in the modification example of the lighting device according to the fourth embodiment.

### DETAILED DESCRIPTION

A lighting device according to an embodiment includes a cover member and a light source body. The cover member is configured to have a tubular shape and at least partially has a light transmitting portion. The light source body includes a plate-shaped and flexible substrate. The substrate is inserted into the cover member along a longitudinal direction of the cover member. A plurality of solid state light emitting elements are disposed on one surface side of the substrate. A cross-sectional shape in a lateral direction of the substrate is along an inner surface of the cover member. In addition, the substrate is configured in such a manner that, on the vertical line where the plurality of solid state light emitting elements are positioned respectively, a distance between each of the adjacent solid state light emitting elements and the inner surface of the light transmitting portion is different from each other.

Hereinafter, a lighting device and a lighting fixture using the lighting device according to the embodiment will be described with reference to the accompanying drawings. In the drawings, like portions are referenced by like reference numerals in the embodiments, and descriptions thereof will not be repeated.

### First Embodiment

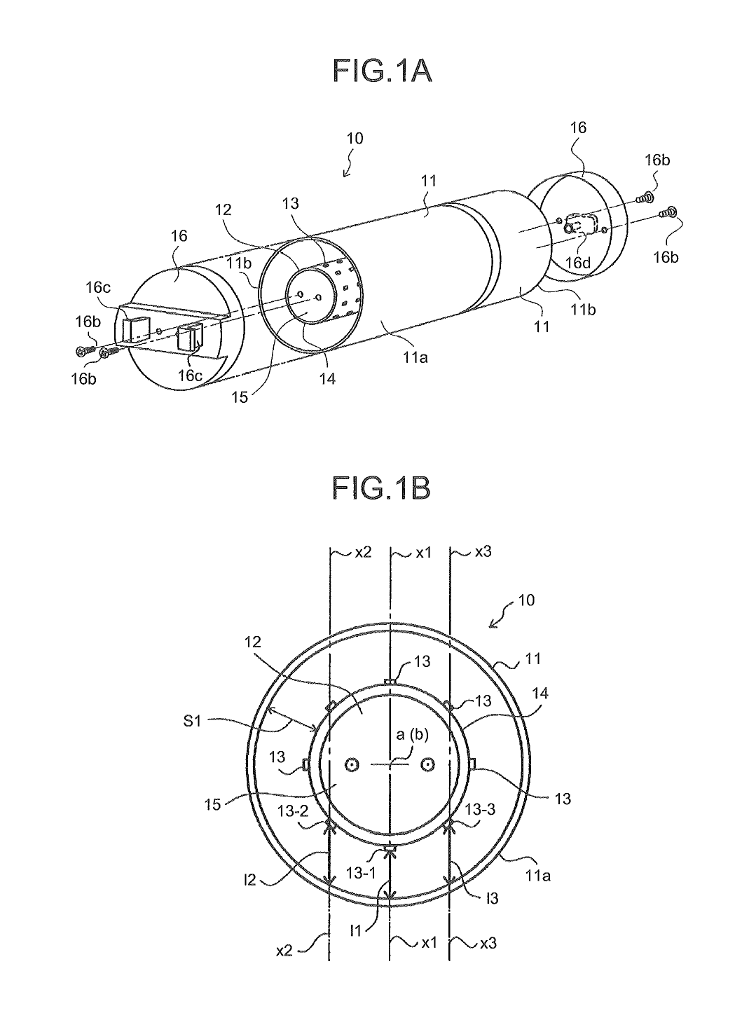

A first embodiment is adapted to include a lighting device which is configured by a straight tubular LED lamp with an L-type cap and a lighting fixture which is configured by base light for industrial facilities and business such as stores and offices using the lighting device. Firstly, the configuration of the lighting device will be described. The lighting device 10, as illustrated in FIGS. 1A and 1B, is configured to have a cover member 11, a light source body 12, a pair of cap members 16 and the like. The cover member 11 is configured to have a tubular shape and to at least partially have a light transmitting portion 11a. The light source body 12 has a substrate 14. The substrate 14 is configured by a plate-shaped and flexible member where a plurality of solid state light emitting elements 13 are disposed on one surface side thereof. The substrate 14 is configured to have a cross-sectional shape in a lateral direction, which is along an inner surface of the cover member 11. And, the substrate 14 is inserted into the cover member 11 along a longitudinal direction of the tube. A pair of cap members 16 is disposed at both ends of the cover member 11.

The cover member 11 is configured to have a tubular shape and to at least partially have a light transmitting portion 11a. In the first embodiment, as illustrated in FIG. 1A, the cover member 11 is configured to have a cylindrical body whose cross-section in a lateral direction is substantially a circular shape, and which forms an elongated straight tubular shape having openings 11b and 11b at both ends thereof. The cover member 11 at least partially has a light transmitting portion 11a. In the first embodiment, the cover member 11 is formed of thin glass or plastic base materials having a light transmitting property in such a manner that the entire cylindrical body which is the cover member 11 forms the light transmitting portion 11a. In addition, in the first embodiment, the entire cylindrical body is formed of polycarbonate resin to which a light diffusion member is added. Furthermore, in the cover member 11, it is preferable that both ends be opened in view of workability for inserting and disposing a light source body 12 described below. However, either one end of the cover member 11 maybe closed. The light source body 12 is inserted into the cover member 11 configured as described above along the longitudinal direction of the cylindrical body.

The light source body 12 has a plurality of solid state light emitting elements 13 (hereinafter, in case of distinguishing an individual solid state light emitting element, the elements are represented by 13-1, 13-2 and the like) and the substrate 14 where the plurality of solid state light emitting elements 13 are disposed on one surface side thereof. In the first embodiment, the solid state light emitting elements 13 are formed of a plurality of SMD (Surface Mount Device) type LEDs which emit white light (including white, cool white and warm white colors and the like). Furthermore, the LEDs 13 may be a COB (Chip on Board) type configured to include LED chips directly mounted on the substrate and a resin including a phosphor excited by the LED chips, which are sealed with the resin, thereby emitting white light. Furthermore, in the first embodiment, the one surface side of the substrate 14 is a surface where LEDs 13 are disposed and the back side thereof is the other surface side.

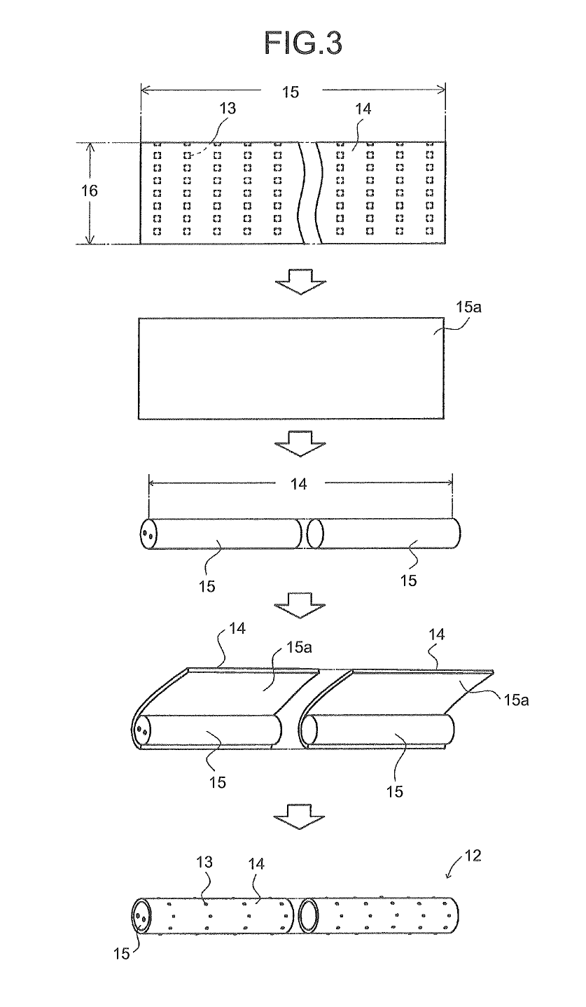

The substrate 14 is formed of a flexible member. In the first embodiment, for example, the substrate 14 has a structure including a sheet of film-shaped insulating body formed of polyimide resin or the like, an adhesive layer on the insulating body, and a conductive foil formed of copper or the like on the adhesive layer, thereby a wiring pattern is configured. In this way, the substrate 14 is formed of a printed circuit board which has flexibility and is largely and freely deformable. Furthermore, the substrate 14 may be formed of metal such as thin aluminum or the like which is subjected to insulation coating or a thin epoxy substrate so as to have flexibility. Then, the substrate 14 formed as described above is formed in a rectangular shape as illustrated in FIG. 3. In the first embodiment, the substrate 14 is formed in a shape of a flat plate which forms a horizontally elongated thin rectangular shape. Then, a plurality of LEDs 13 are disposed so as to be positioned at substantially equal intervals in a matrix shape with respect to one surface side of the substrate 14. Each of the plurality of LEDs 13 is serially connected to each other by a wiring pattern.

The substrate 14 configured in the shape of a plate as described above, is configured such that the cross-sectional shape in the lateral direction is along the inner surface of the cover member 11 using the flexibility of the substrate. In the first embodiment, the substrate 14 is configured to be along the inner surface of the cover member 11 forming a cylindrical body. That is, the substrate 14 has a shape forming a cylindrical body and is configured in such a manner that, on the vertical line where the plurality of LEDs 13 are positioned respectively, a distance between each of the adjacent LEDs 13 and the inner surface of the cover member 11 is different from each other.

For example, as illustrated in FIG. 1B, a distance between an LED 13-1 on the vertical line x1-x1 where the LED 13-1 is positioned and the inner surface of the cover member 11 is set to 11. In addition, in LEDs 13-2 and 13-3 which are positioned adjacent to the LED 13-1 transversely, a distance on the vertical line x2-x2 and x3-x3 between the LED 13-2 and 13-3, and the inner surface of the cover member 11 is set to 12 and 13 respectively. In this case, the substrate 14 is configured in a shape of the cylindrical body so that the relations become 11<12 and 11<13. Furthermore, in the first embodiment, the substrate 14 is configured such that the cross-sectional shape of the substrate 14 in the lateral direction is along the inner surface of the cover member 11 using a flexibility of the substrate 14. However, shapes of the substrate 14 and the cover member 11 are not necessarily coincident with each other and a substantially coincident shape is allowed.

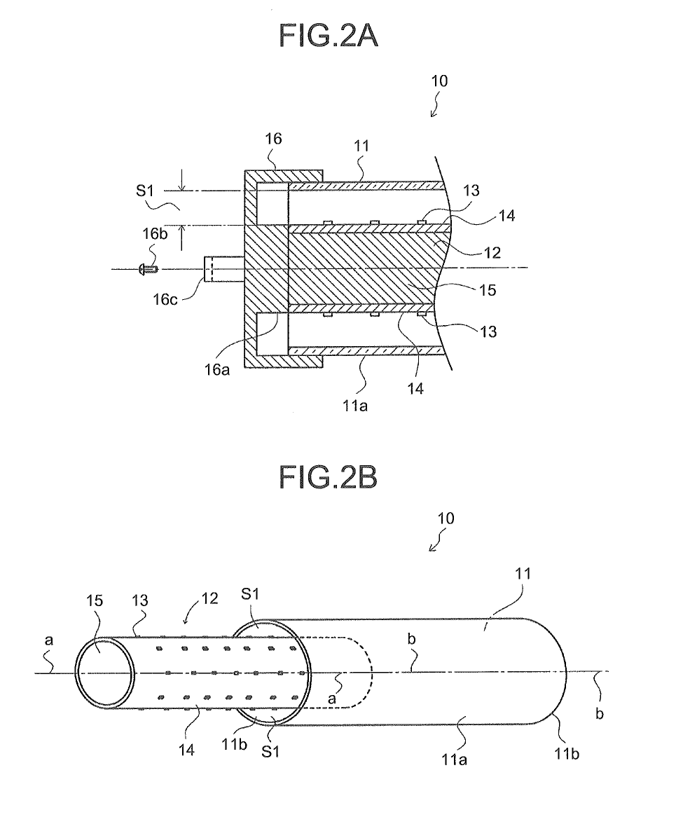

As illustrated in FIGS. 2A and 2B, an outer diameter of the substrate 14 having a cylindrical body is formed to be smaller than an inner diameter of the cover member 11 made of a cylindrical body. Then, the substrate 14 is inserted into the cover member 11 by making the longitudinal axial line a-a of the substrate 14 having a cylindrical body substantially coincide with the longitudinal axial line b-b of the cover member 11 similarly having a cylindrical body. As a result, a space S1 with substantially equal intervals around the entire periphery is formed between the inner surface of the cover member 11 and the outer surface of the substrate 14. Each of LEDs 13 is disposed at a position substantially equally separated from the inner surface of the cover member 11, and when the light is switched on, it is possible to suppress the LED 13 with a high brightness from being visually recognized as dots.

The other surface side of the substrate 14 configured as described above is supported in close contact with a heat conducting member 15. As illustrated in FIG. 3, the heat conducting member 15 is configured by metal having heat conductivity. In the first embodiment, the heat conducting member 15 is configured by an elongated circular column body made of aluminum (Al). The circular column body may have a hollow cylindrical shape. With respect to an outer peripheral surface of the circular column body, the substrate 14 is wound using the flexibility of the substrate. In other words, the flexible substrate is wound using the heat conducting member 15 as a core member. In this way, the substrate 14 is supported in close contact with the outer peripheral surface of the heat conducting member 15.

In addition, the other surface side of the substrate 14 is supported in close contact with the heat conducting member 15 by interposing an adhesive tape 15a made of silicon resin, epoxy resin or the like that has a good electrical insulation, heat resistance and thermal conductivity, between the outer peripheral surface of the heat conducting member 15 and the other surface side of the substrate 14. Alternatively, the other surface side of the substrate 14 may be supported in close contact with the heat conducting member 15 by applying the adhesive material made from those members between the outer peripheral surface of the heat conducting member 15 and the other surface side of the substrate 14. In addition, a length 14 of the heat conducting member 15 is configured so as to be substantially equal to a width 15 of the substrate 14 forming a plate-shape (14≅15). In addition, a vertical length 16 of the substrate 14 is configured so as to be substantially equal to the peripheral length of the heat conducting member 15 forming a cylindrical body. In this way, the substrate 14 is supported in close contact so as to substantially cover the outer periphery of the heat conducting member 15. Furthermore, it is possible to adapt a configuration so that the substrate 14 is not protruded from both ends of the heat conducting member 15 or the heat conducting member 15 is not exposed.

By a configuration as described above, the substrate 14 is configured by a plate-shaped flexible member and the plurality of LEDs 13 are disposed on one surface side thereof. Then, the substrate 14 is inserted into the cover member 11 along the longitudinal direction of the tube. Then, the substrate 14 is configured so that the cross sectional shape in the lateral direction is along the inner surface of the cover member 11. And the substrate 14 is configured in such a manner that, on the vertical line where the plurality of LEDs 13 are positioned respectively, a distance between each of the adjacent LEDs 13 and the inner surface of the light transmitting portion 11a is different from each other. In this way, the light source body 12 is configured.

In the light source body 12 configured as described above, the other surface side (back side) of the substrate 14 where LEDs 13 are disposed on one surface side thereof is supported in close contact with the outer peripheral surface of the heat conducting member 15 made of aluminum having a thermal conductivity. For this reason, heat generated from the LEDs 13 when the light is switched on is transmitted to the heat conducting member 15 from the backside of the substrate 14. Since the heat conducting member 15 is configured by an elongated circular column body and has a large heat capacity, the heat generated in the substrate can be uniformized. Particularly, in the first embodiment, the outer peripheral surface of the heat conducting member 15 is in close contact with the other surface side of the substrate 14 by interposing the adhesive tape 15a made of silicon resin, epoxy resin or the like with a good thermal conductivity, between the outer peripheral surface of the heat conducting member 15 and the other surface side of the substrate 14. For this reason, the heat from the LED 13 can be transmitted to the heat conducting member 15 with a reduced loss. In addition, since a decrease in a luminous efficiency of the LED 13 is suppressed, it is possible to prevent the decrease in luminance due to a decrease in the light flux. At the same time, it is possible to achieve a long-term duration of LED 13.

In addition, the heat conducting member 15, as illustrated in FIG. 3, is used as a core member for configuring a cylindrical body by winding therearound the plate shaped substrate 14. At the same time, the heat conducting member 15 can also be used as a heat radiation member of the LED. For this reason, when both ends of a lamp that is configured in an elongated shape are held by caps, since the heat conducting member 15 where the caps are fixed to both ends thereof has little deformation caused by its own weight, a deflection of the lamp can be suppressed. In addition, since a particular member for the heat radiation is not needed, it is possible to simplify the configuration by reducing the number of components and to make assembling work easy. In addition, it is possible to provide the lighting device and the lighting fixture that are advantageous in cost. In addition, the heat conducting member 15 is inserted into the cover member 11 forming an elongated circular column body, in the longitudinal direction thereof. As a result, it is possible to increase the strength, particularly the strength in the longitudinal direction, of the elongated substrate 14 and further the entire elongated lighting device 10 including the cover member 11.

At both ends of the cover member 11 forming a tubular shape into which the light source body 12 is inserted as described above, a pair of cap members 16 is disposed as described in FIG. 1A. Then, the longitudinal axial line a-a of the light source body 12 forming a cylindrical body is coincident with the longitudinal axial line b-b of the cover member 11, whereby the light source body 12 is supported by the pair of cap members 16, in the cover member 11. At the same time, the openings 11b and 11b on both ends of the cover member 11 are closed by the pair of cap members 16. The cap members 16, as illustrated in FIG. 2A, are formed of synthetic resin having a heat resistance and electrical insulation in a shape of a circular cap. In the first embodiment, the cap members 16 are formed of white PBT (polybutylene terephthalate) in a shape of the circular cap. Then, on the concentric circle centered on the cap in the circular inner surface, a supporting convex portion 16a is integrally formed. In this case, the inner diameter of the cap members 16 is configured to be equal to or slightly larger than the outer diameter of the cover member 11. In addition, the outer diameter of the supporting convex portion 16a is configured to be equal to or slightly larger than the outer diameter of the light source body 12 forming a cylindrical body.

In this way, as illustrated in FIG. 2A, in a state where the light source body 12 is inserted into the cover member 11, the cap member 16 is inserted into the openings 11b and 11b of the cover member 11, and the openings at both ends are closed thereby. At the same time with this insertion, both ends of the light source body 12 forming a cylindrical body comes into contact with the supporting convex portion 16a of the cap member 16, and the light source body 12 is supported in the cover member 11. Then, the light source body 12 is supported in the cover member 11 by being screwed, using screws 16b and 16b from the outer surface of the cap member 16, to both end surfaces of the heat conducting member 15 forming a circular column body of the substrate 14. At the same time, the pair of cap members 16 is fixed to both ends of the cover member 11. In addition, the cap members 16 may be fixed to the cover member 11 using an adhesive made from silicon resin, epoxy resin or the like with a heat resistance.

By a configuration described above, the light source body 12 forming a cylindrical body, in the state where the axial line a-a in a longitudinal direction of the light source body 12 is substantially coincident with the axial line b-b in the longitudinal direction of the cover member 11 forming a straight tubular shape, is supported along the longitudinal direction of the straight tube. Then, each of the LEDs 13 disposed on the substrate 14 forming a cylindrical body is disposed in the cover member 11, in a state where the space dimension S1 between the LED 13 and the inner surface of the cover member 11 is substantially the same over the entire periphery of the cylinder.

As a result, when the LED 13 is switched on, the light emitted from the LED 13 is emitted substantially uniformly toward the entire periphery of the inner surface of the cover member 11, and substantially uniform light is emitted over all directions from the cover member 11. Then, in the various lighting fixtures, it is possible to perform an intended light distribution control over all the direction, by a combination with light control members such as a reflector. Therefore, it is possible to provide a lighting device with which a light distribution control can be freely performed in all intended directions of 360°, similarly to a straight tubular fluorescent lamp. At the same time, since the substrate 14 itself has flexibility and is formed of a thin film-like member, it is also possible to reduce the weight of the entire lamp.

In addition, in one of the cap members 16, a pair of terminals 16c for supplying the power is provided, the terminals 16c and an input terminal of the light source body 12 are electrically connected to each other, and the electric power is supplied to the LED 13 via a light switching unit. In the other cap member 16, a grounding terminal 16d is provided, and the lighting device 10 is configured by a straight tubular shaped LED lamp with an L-type cap. The lighting device according to the first embodiment is configured to have a straight tubular shaped LED lamp with the L-type cap corresponding to a current 40W type straight tubular shaped fluorescent lamp, which has a dimension of approximately 1200 mm in length and approximately 25.5 mm in the outer diameter of the cover member 11.

In addition, alight switching unit for a light switching control of the LEDs 13 is provided at the lighting fixture side to which the lighting device 10 configured as described above is incorporated. Then, the light switching control is performed by supplying the power to the LEDs 13 from the terminal 16c of the lighting device 10 mounted in the lighting fixture via the light switching unit in the fixture from the commercial power source. In addition, the light switching unit may be configured to be built in the lighting device 10. In this case, the heat conducting member 15 may be configured to be a pipe formed in a cylindrical body and the light switching unit may be disposed in the pipe. As a result, it is possible to configure the lighting device 10 without decreasing the area of the substrate 14, that is, the area of the light emitting surface. In addition, the heat generated from the circuit components and the like of the light switching unit can be absorbed by the heat conducting member 15 made of aluminum and eventually a reliability of the circuit components can be improved. In addition, the inside of the heat conducting member 15 tube which may be a dead space can be effectively utilized and thereby the size of the lighting device can be reduced.

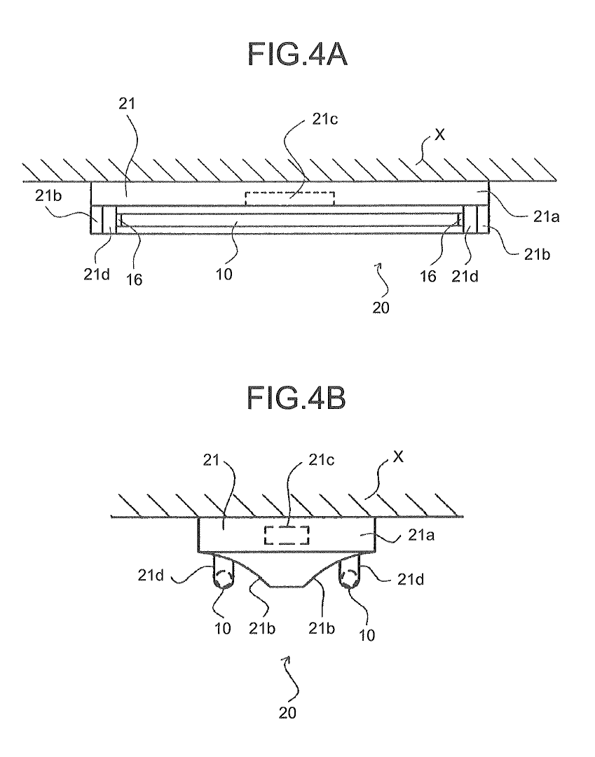

Next, a configuration of the lighting fixture using the lighting device 10 according to the first embodiment will be described. The lighting fixture 20 according to the first embodiment is a lighting fixture which configures a base light or the like for industrial facilities and business such as stores and offices. The lighting fixture 20, as illustrated in FIGS. 4A and 4B, is configured by a fixture main body 21 and the lighting device 10 described above which is mounted on the fixture main body. The fixture main body 21 is configured to include a base portion 21a forming an elongated rectangular box-shape, which is configured by a white color coated steel plate, and a pair of reflection plates 21b and 21b forming a substantially inverted triangle which is provided on the lower surface of the base portion. The light switching unit 21c is built in the base portion 21a. The light switching unit 21c is configured to have a lighting circuit which converts a 100V AC voltage into an approximately 24V DC voltage and supplies a constant current to each of the LEDs 13 of the lighting device 10.

On each of the reflection plates 21b, a pair of sockets 21d and 21d on which the cap members 16 provided on the lighting device 10 are mounted, is provided. Two lighting devices 10 configured as described above are respectively mounted on the pair of sockets 21d and 21d, whereby the lighting fixture 20 being configured. The lighting fixture 20 configured as described above is connected to the commercial power source and directly attached to a ceiling X or the like of a room. When the lighting fixture 20 is switched on, the power is supplied from the commercial power source to each of the LEDs 13 via the light switching unit 21c, the sockets 21d and 21d, and the cap members 16 of the lighting device 10, and then room illumination is performed by emitting the white light.

In this case, the lighting device 10, as described above, emits substantially uniform light over all the directions of the cover member 11. As a result, it is possible to widely perform a light distribution control in such a manner that the light emitted to the fixture main body side (light on the back side) is reflected toward the inside of the room including a directly below portion in the room, by a pair of reflection plates 21b and 21b forming a substantially inverted triangle. In other words, in a variety of lighting fixtures, it is possible to perform an intended light distribution control in every direction by a combination with the reflection plates. Therefore, it is possible to provide a lighting fixture with which a light distribution control can be freely performed in every intended direction of 360°, similarly to the straight tubular fluorescent lamp.

In addition, the heat generated when the LEDs 13 are switched on is transmitted from the surface of the substrate 14 to the cover member 11 and radiated from the outer surface of the cover member 11 to the outside. At the same time, the heat generated from the rear surface side of the LEDs 13 is transferred from the other surface side of the substrate 14 to the heat conducting member 15 made of aluminum and then is uniformized by the heat capacity of the heat conducting member 15.

### Second Embodiment

A second embodiment has a configuration in which the cross sectional shape of the substrate 14 formed of the flexible member in the lateral direction is a circular arc-shape (substantially semi-circular shape). Hereinafter, the configuration will be described with the like reference numerals being given to like portions as the first embodiment.

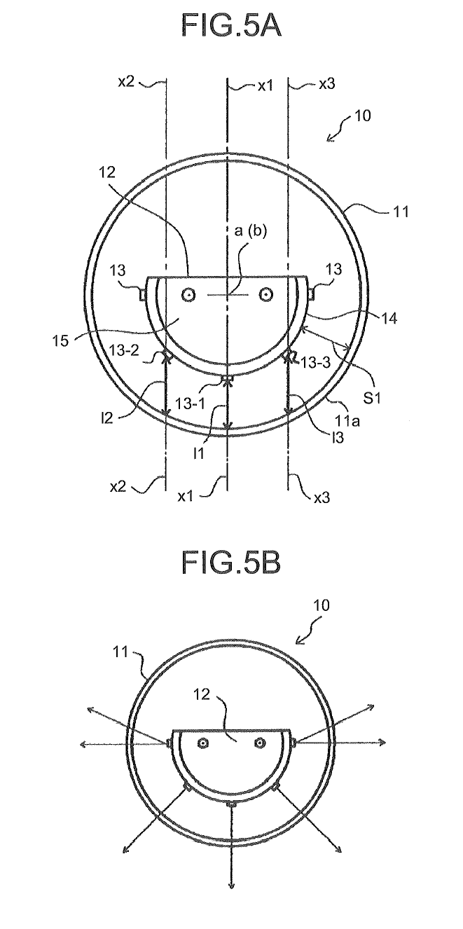

As illustrated in FIG. 5A, the substrate 14 is configured in a plate shape and has flexibility. The substrate 14 is configured such that the cross-sectional shape of the substrate 14 in the lateral direction is along the inner surface of the cover member 11 using the flexibility. In the second embodiment, the substrate 14 is configured to have a shape along the inner surface of the lower half of the cover member 11 forming a cylindrical body, that is, a shape of the substantially semi-cylindrical body. In addition, the substrate 14 is configured in such a manner that, on the vertical line where a plurality of LEDs 13 are positioned respectively, a distance between each of the adjacent LEDs 13 and the inner surface of the cover member 11 is different from each other.

For example, as illustrated in FIG. 5A, in the substrate 14, a distance between an LED 13-1 on the vertical line x1-x1 where the LED 13-1 is positioned and the inner surface of cover member 11 is set to 11. In addition, in LEDs 13-2 and 13-3 which are positioned adjacent to LED 13-1 transversely, a distance on the vertical line x2-x2 and x3-x3 between the LEDs 13-2 and 13-3, and the inner surface of the cover member 11 is set to 12 and 13 respectively. In this case, the substrate 14 is configured in a shape of a substantially semi-cylindrical body so that the relations become 11<12 and 11<13.

The outer diameter of the substrate 14 formed of the substantially semi-cylindrical body is configured to be smaller than the inner diameter of the cover member 11 formed of the cylindrical body. Then, the substrate 14 is inserted into the cover member 11 by making the longitudinal axial line a-a of the substrate 14 formed of the substantially semi-cylindrical body substantially coincident with the longitudinal axial line b-b of the cover member 11. As a result, a space S1 with a substantially equal interval is formed between the inner surface of the lower half of the cover member 11 and the outer surface forming a circular arc-shape (substantially semi-cylindrical body) of the substrate 14.

Furthermore, the heat conducting member 15 is configured to be a long solid semicircular column body. Then, the substrate 14 is wound to the circular arc-shaped outer peripheral surface of the semicircular column body using the flexibility of the substrate. That is, the substrate 14 is wound using the heat conducting member 15 as a core member. In this way, the other surface side of the substrate 14 is supported in close contact with the circular arc-shaped outer peripheral surface of the heat conducting member 15.

According to the second embodiment, light emitted from each of the LEDs 13, as illustrated by arrows in FIG. 5B, is substantially uniformly emitted slightly toward the rear surface side from the substantially lower half periphery of the inner surface of the cover member 11 formed of the cylindrical body. Hence, substantially uniform light from the cover member 11 is emitted over the substantially lower half peripheral direction of the cover member 11. Therefore, in a variety of lighting fixtures, by a combination with the light control member such as reflectors, it is possible to more widely perform a light distribution control compared to the case of using a plate-shaped substrate.

In addition, in the substrate 14 and the heat conducting member 15 configuring the light source body 12, lighting device can be manufactured efficiently. For example, it is possible to simultaneously configure two light source bodies by equally dividing the substrate 14 forming a cylindrical body and the heat conduction member 15 forming a circular column body described in the first embodiment into two in the longitudinal direction. Therefore, it is possible to provide a lighting device which is more advantageous in cost. Furthermore, since the cover member 11 is formed of a cylindrical body which is similar to the appearance of the straight tubular shaped fluorescent lamp, it is possible to provide a straight tubular shaped lighting device with an excellent merchantable quality and without imparting a discomfort compared to the fluorescent lamp. In addition, the heat conducting member 15 has little deformation caused by its own weight. Therefore, it is possible to suppress the deflection of the lamp when the caps on both ends are held.

Furthermore, in the second embodiment, a reflection type lighting device may be configured by applying a reflective film or the like to the inner surface of the cover member 11 opposing the upper part of the substrate 14 where the circular arc thereof is opened, so that the cover member 11 causes partially the light emitted upward to be reflected downward. In addition, the other configurations, operations, operational effects and exemplary modifications in the second embodiment are similar to those in the first embodiment.

### Third Embodiment

A third embodiment has a configuration in which the LEDs 13 are disposed on the other surface side of the substrate 14 in the second embodiment. Hereinafter, the configuration will be described with the like reference numerals being given to like portions as the first and second embodiments.

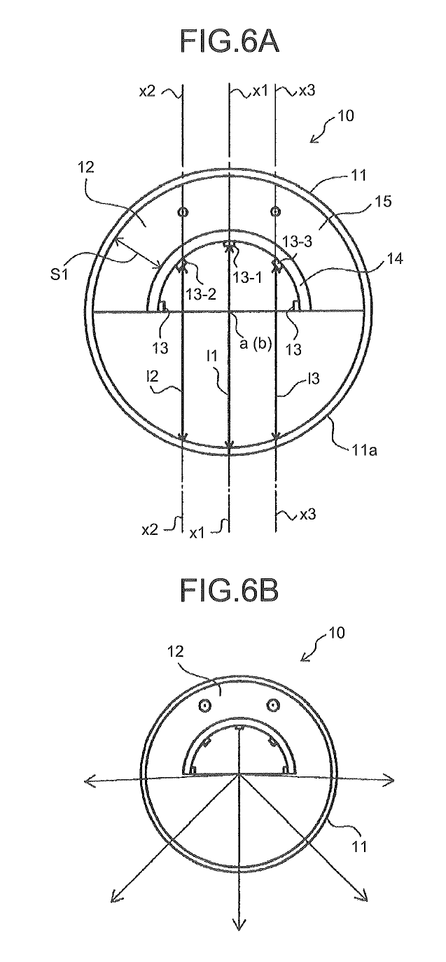

As illustrated in FIG. 6A, a plurality of LEDs 13 which are solid state light emitting elements are disposed on the other surface side of the first and second embodiments in the substrate 14 formed in the plate shape, that is, on the lower side thereof in FIG. 6A. In addition, in the third embodiment, hereinafter, the lower side in FIG.6A is referred to as one surface side and the upper side is referred to as the other surface side, and thereby the configuration will be described. Then, the substrate 14 is configured such that the cross-sectional shape of the substrate 14 in the lateral direction is along the inner surface of the cover member 11 using flexibility of the substrate. In the third embodiment, the substrate 14 is configured to have a shape along the inner surface of the upper half of the cover member 11 forming a cylindrical body, that is, a shape of the substantially semi-cylindrical body. In addition, the substrate 14 is configured in such a manner that, on the vertical line where a plurality of LEDs 13 are positioned respectively, a distance between each of the adjacent LEDs 13 and the inner surface of the cover member 11 which forms the light transmitting portion 11a is different from each other.

For example, as illustrated in FIG. 6A, a distance between an LED 13-1 and the inner surface of the cover member 11 on the vertical line x1-x1 where the LED 13-1 is positioned is set to 11. In addition, in LEDs 13-2 and 13-3 which are positioned adjacent to LED 13-1 transversely, a distance between the LED 13-2 and 13-3, and the inner surface of the cover member 11 on the vertical line x2-x2 and x3-x3 is set to 12 and 13 respectively. In this case, the substrate 14 is configured in a shape of a semi-cylindrical body so that the relations become 11>12 and 11>13.

Then, the outer diameter of the substrate 14 formed of the substantially semi-cylindrical body is configured to be smaller than the inner diameter of the cover member 11 formed of a cylindrical body. Then, the substrate 14 is inserted into the cover member 11 by making the longitudinal axial line a-a of the substrate 14 formed of the semi-cylindrical body substantially coincident with the longitudinal axial line b-b of the cover member 11. As a result, a space S1 with a substantially equal interval is formed between the inner surface of the upper half of the cover member 11 and the outer surface of the semi-cylindrical body of the substrate 14.

Furthermore, the heat conducting member 15 is configured to have a long semi-cylindrical body which is fitted in the space S1 formed between the inner surface of the upper periphery of the cover member 11 and the outer surface of the substrate 14. Then, with respect to the inner peripheral surface of the circular arc shape of the semi-cylindrical body, the substrate 14 is pressed using the flexibility of the substrate. That is, the substrate is pressed using the heat conducting member 15 as a shaping member. In this way, the other side of the substrate 14 is supported in close contact with the inner peripheral surface of the heat conducting member 15, whereby the light source body 12 is configured. In the light source body 12 configured as described above, the heat conducting member 15 is fitted in the space Si, Hence the outer surface side of the heat conducting member 15 is supported in close contact with the upper half periphery of the inner surface of the cover member 11. As a result, in the third embodiment, the cover member 11 is configured so that the lower half periphery thereof becomes a light transmitting portion 11a without transmitting the light through the heat conducting member at the upper half periphery thereof. That is, in the third embodiment, the cover member 11 at least partially having the light transmitting portion is configured in such a manner that the lower half periphery of the cylindrical body becomes the light transmitting portion 11a.

As a result, the light emitted from the LEDs 13 disposed on one surface side of the substrate 14 formed of a semi-cylindrical body, that is, on the inner peripheral surface side of the substrate 14 is substantially uniformly emitted toward the substantially lower half periphery of the inner surface of the cover member 11, as illustrated by arrows in FIG. 6B. Hence, the substantially uniform light is emitted from the cover member 11 over the substantially lower half peripheral direction. Therefore, in a variety of lighting fixtures, by a combination with the light control member such as reflectors, it is possible to more widely perform a light distribution control compared to the case of using the plate-shaped substrate.

In the third embodiment, the substrate 14 may be configured in such a manner that a reflection rate of one surface on a side where the LEDs 13 are disposed is equal to or greater than 80% by performing white color coating or mirror finishing. In this way, on the surface of the substrate, the absorption of the light emitted from the LEDs 13 can be suppressed and the light loss can be reduced, hence it is possible to perform more bright illumination. For example, the substrate 14 may be configured by a metal member, and a mirror surface may be used for one surface side thereof. In this way, the light emitted from the LEDs 13 may be reflected from the mirror surface part between the LEDs 13 by increasing the reflection rate of one surface side of the substrate 14, and the light can be emitted from the entire surface of the substrate 14. In addition, the other configurations, operations, operational effects and exemplary modifications in the third embodiment are similar to those of the first and second embodiments.

### Fourth Embodiment

A fourth embodiment has a configuration of the lighting device 10 having a shape of semi-cylindrical body by configuring the cover member 11 formed of a cylindrical body in the third embodiment as a semi-cylindrical body. Hereinafter, the configuration will be described with like reference numerals being given to like portions as the first, second and third embodiments.

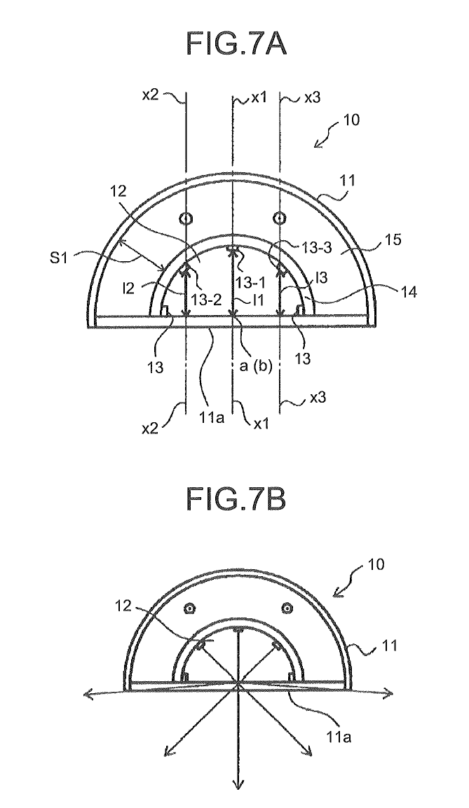

As illustrated in FIG. 7A, the cover member 11 is configured to have a semi-cylindrical body with the lower part thereof being opened, where the cross-sectional shape in the lateral direction is a circular arc shape (semicircular shape). The opened lower part is closed by forming a light transmitting portion 11a using a light transmitting plate. The light transmitting plate is configured by a light transmitting member similar to the cover member 11. In addition, on the substrate 14 configured in a plate shape, a plurality of LEDs 13 which are solid state light emitting elements are disposed on the other surface side thereof in the first and second embodiments, that is, on the lower side thereof in FIG. 7A. In addition, hereinafter, in the fourth embodiment, the lower side in FIG. 7A is referred to as one surface side and the upper side is referred to as the other surface side, and the configuration will be described. Then, the substrate 14 is configured to have a cross-sectional shape in the lateral direction which is along the inner surface of the cover member 11 using the flexibility of the substrate. In the fourth embodiment, the substrate 14 is configured in a shape along the inner surface of the cover member 11 forming the semi-cylindrical body, that is, in a shape forming the semi-cylindrical body. In addition, the substrate 14 is configured in such a manner that, on the vertical line where the plurality of LEDs 13 are positioned respectively, a distance between each of the adjacent LEDs 13 and the inner surface of the cover member 11 which configures the light transmitting portion 11a is different from each other.

For example, as illustrated in FIG. 7A, a distance between an LED 13-1 and the inner surface of the cover member 11 on the vertical line x1-x1 where the LED 13-1 is positioned is set to 11. In addition, in LEDs 13-2 and 13-3 which are positioned adjacent to LED 13-1 transversely, a distance between the LED 13-2 and 13-3, and the inner surface of the cover member 11 on the vertical line x2-x2 and x3-x3 is set to 12 and 13 respectively. In this case, the substrate 14 is configured in the shape of a semi-cylindrical body so that the relations become 11>12 and 11>13.

Then, the outer diameter of the substrate 14 formed of the substantially semi-cylindrical body is configured to be smaller than the inner diameter of the cover member 11. Then, the substrate 14 is inserted into the cover member 11 by making the longitudinal axial line a-a of the substrate 14 formed of the semi-cylindrical body substantially coincident with the longitudinal axial line b-b of the cover member 11. As a result, a space S1 with a substantially equal interval is formed between the inner surface of the cover member 11 and the outer surface of the semi-cylindrical body of the substrate 14.

The heat conducting member 15 is configured to have a long semi-cylindrical body which is fitted in a space S1 formed between the inner surface of the cover member 11 and the outer surface of the substrate 14. Then, with respect to the inner peripheral surface of the circular arc shape of the semi-cylindrical body, the substrate 14 is pressed using the flexibility of the substrate 14. That is, the substrate 14 is pressed to the heat conducting member 15 using the heat conducting member 15 as a shaping member. In this way, the other surface side of the substrate 14 is supported in close contact with the inner peripheral surface of the heat conducting member 15, whereby the light source body 12 is configured.

The light source body 12 configured as described above is inserted into the cover member 11 so that the heat conducting member 15 is fitted in the space Si. Hence the outer surface side of the circular arc-shaped heat conducting member 15 is supported in close contact with the circular arc-shaped inner surface of the cover member 11. As a result, in the fourth embodiment, the circular arc-shaped part of the cover member 11 is configured in such a manner that the opened lower part thereof becomes a light transmitting portion 11a without transmitting the light through the heat conducting member 15 in the circular-arc shaped part thereof. That is, in the fourth embodiment, the cover member 11 at least having the light transmitting portion is configured in such a manner that the opened lower part of the cylindrical body becomes the light transmitting portion 11a.

As a result, the light emitted from the LEDs 13 disposed on one surface side of the substrate 14, that is, on the inner peripheral surface of the substrate 14 is substantially uniformly emitted toward the substantially lower half periphery of the circle of the cover member 11 from the opened light transmitting portion 11a in the lower part of the cover member 11, as illustrated by arrows in FIG. 7B, substantially similarly to the case in the third embodiment. Therefore, in a variety of lighting fixtures, by a combination with the light control member such as reflectors, it is possible to more widely perform a light distribution control compared to the case of using the plate-shaped substrate in the related art.

In addition, in the substrate 14 and the heat conducting member 15 configuring the cover member 11 and the light source body 12, it is easy to handle the materials. For example, the cover member 11 formed of a cylindrical body, the substrate 14 formed of a cylindrical body and the heat conducting member 15 formed of a circular column body, which are described in the first embodiment, may be divided into two in the longitudinal direction. In this manner, it is possible to simultaneously configure two cover members 11 and two light source bodies 12. Therefore, it is possible to provide a lighting device which is more advantageous in cost.

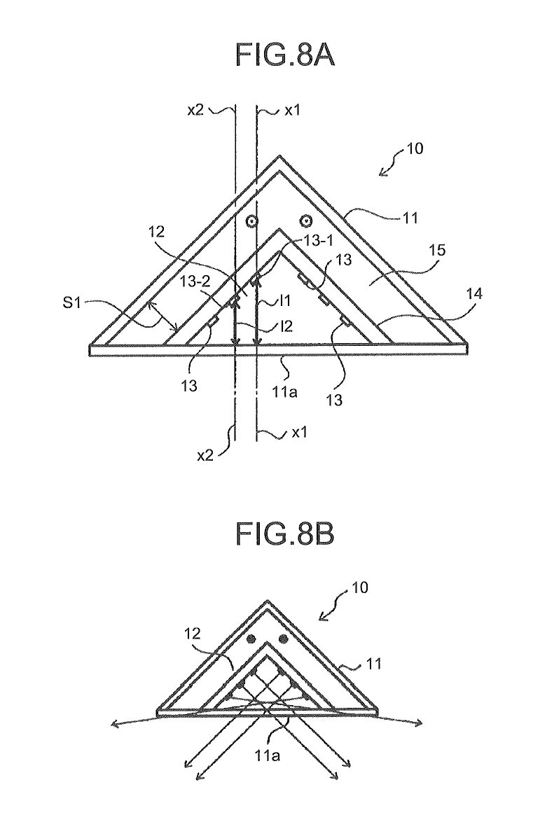

In addition, as illustrated in FIGS. 8A and 8B, the cover member 11 may be configured to have a triangle pipe body where a cross-sectional shape on the lateral direction thereof is not a circular-arc but a triangle. In this case, the substrate 14 is configured to be in a shape along the inner surface of the cover member 11, that is, to have a triangle pipe body in the present configuration. The heat conducting member 15 is also configured to have a long solid triangle pillar body which is fitted in a space S1 formed between the inner surface of the cover member 11 and the outer surface of the substrate 14. According to the configuration, similarly to the configuration described above, the light distribution control can be more widely performed compared to the case of using the plate-shaped substrate in the related art. Furthermore, in the exemplary modification illustrated in FIGS. 8A and 8B, like portions are given by like reference numerals as in FIGS. 7A and FIG. 7B and the detailed descriptions thereof will not be repeated. In addition, the other configurations, operations, operational effects and exemplary modifications in the fourth embodiment are similar to those in the first, second and third embodiments.

In each embodiment as described above, the cover member 11 and the substrate 14 may be configured in such a manner that the cross-sectional shape thereof in the lateral direction is not limited to circular or a circular arc shape. It also may be configured to have a polygonal shape such as a hexagonal or octagonal shape, further an elliptical shape. In this case, similarly, the heat conducting member 15 which becomes the core member and the shaping member also may be configured to be a polygonal shape such as a hexagonal or octagonal shape, further an elliptical shape.

In addition, the heat conducting member 15 is configured by a solid circular column body or the like, however it may also be configured by a pipe formed of a cylindrical body or the like. According to this, it is possible to further reduce the weight of the lighting device 10. In addition, the light source body 12 may be configured by only the substrate 14 by omitting the heat conducting member 15. In this case, the substrate 14 may be formed to be a cylindrical body or the like using the substrate itself or using a jig or a mold.

In addition, the heat generated from the LEDs 13 is configured to be uniformized by the heat conducting member 15. However, the heat conducting member 15 may be configured by a pipe and further a vent hole which communicates with the outside may be formed on the supporting convex portion 16a on each of the pair of cap members 16. Then the heat conducting member 15 may be configured in such a manner that the inside of the pipe of the heat conducting member 15 communicates with the outside. According to this configuration, when the lighting is switched on, the outside air flows into the vent hole of one of the cap members 16 through the gap of the socket and cools down the inner surface of the heat conducting member 15. Then, due to the action of convection, the heat flows out from the vent hole of the other cap member 16. As a result, the heat conducting member 15, the substrate 14 which is in close contact with the heat conducting member and the LEDs 13 can be cooled down, and hence it is possible to more effectively perform a heat radiation operation. Furthermore, in a case where a light switching unit is provided in the pipe of the heat conducting member 15, the circuit components can be effectively cooled down in a similar way, and it is possible to further increase the reliability of the circuit components.

In addition, in the embodiments, a straight tubular shaped lighting device similar to a straight tubular shaped fluorescent lamp is configured. However, lighting devices with various external shapes, applications, for example, a lighting device with an annular shape may be applicable. In addition, a lighting device with a cap is configured, however, a lighting device without the caps, for example, a lighting device that is directly incorporated into the fixture without using the caps may be applicable. In addition, in the embodiments, a lighting device with the length of approximately 1200 mm is configured. However, a lighting device with the length of approximately 600 mm, further approximately 2400 mm may be configured and lighting devices with various lengths maybe configured depending on the applications. Furthermore, a lighting device having a minute outside tube diameter may be configured.

As the solid state light emitting element 13 that configures the light source body 12, for example, an LED chip made of gallium nitride (GaN)-based semiconductor which emits blue light may be preferably used. However, a solid state light emitting element such as a semiconductor laser and an organic EL may be allowed to be used as a light source. In addition, the configuration is made to emit the white light, however, the red, blue, green light or the like and further a combination of various colors may be applicable depending on the usage of the lighting device. In addition, the solid state light emitting elements 13 are disposed on one surface side of the substrate 14 in a matrix form. However, all or part of the solid state light emitting elements may be disposed regularly and with a certain order in a plane-shape such as a staggered shape or a radial shape, and may be actually mounted on the substrate. In addition, for the shape of the substrate 14, in order to configure a straight tubular shaped lighting device, a rectangular shape such as a rectangle or a square is preferable. However a configuration with a polygonal shape such as a hexagonal or octagonal shape in a tubular shape may be applicable.

In the cover member 11, in order to increase light distribution characteristics, reflection means such as a reflection film may be formed on a part of the inner surface thereof. In addition, the cover member 11 is preferably configured to have an enclosure to substantially seal the light source body 12. However, it is not necessary to completely seal the light source body but optical sealing may be sufficient, and for example, a small vent hole or the like may be formed on a part of the cover member 11. For the cap member 16, a pin-shaped terminal of G13 type generally used in the straight tubular fluorescent lamp may be used and is not limited to any specific cap. In addition, the light switching unit which performs a light switching control of the solid state light emitting elements 13 may include a dimming circuit for dimming the solid state light emitting elements and a toning circuit.

The heat conducting member 15, in order to increase the absorbency and the radiation of the solid state light emitting elements 13, may preferably be formed of a metal with a good thermal conductivity, for example, a metal containing at least one of aluminum (Al), copper (Cu), ferrite (Fe) and nickel (Ni). Besides, the heat conducting member 15 may be formed of industrial materials such as aluminum nitride (AlN) and silicon carbide (SiC). Furthermore, resin with a high thermal conductivity may be used. Furthermore, in a case where the heat conducting member 15 is configured in a pipe shape, in order to further increase a heat radiation capability, a large number of heat radiation fins radially protruding from one end portion side toward the other end side and heat radiation pins radially protruding may be integrally formed on the inner peripheral surface thereof.

As exemplified in the embodiments, the lighting fixture may be configured for industrial facilities and business such as stores and offices but without being limited thereto, lighting fixtures may be configured for various types of residential uses, as well as outdoor uses such as security lights, street lights or road lights. Although preferred embodiments of the present invention have been described, the invention is not limited to the embodiments described above, various modification examples may be adopted within the scope of the present invention.

As described above, the lighting device and lighting fixture according to the configurations in the embodiments, include a cover member and a light source body. The cover member is configured to have a tubular shape and to at least partially have a light transmitting portion. The light source body has a plate-shaped flexible substrate configured such that the substrate is inserted into the cover member along the longitudinal direction of the cover member, and a plurality of solid state light emitting elements are disposed on one surface side thereof, and the cross-sectional shape in a lateral direction is along the inner surface of the cover member. And the substrate is configured in such a manner that, on the vertical line where the plurality of solid state light emitting elements are positioned respectively, a distance between each of the adjacent solid state light emitting elements and the inner surface of the light transmitting portion is different from each other. Therefore, it is possible to provide a lighting device and a lighting fixture with which a wide light distribution control can be realized.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes may be made without departing from the spirit of the inventions. The accompanying claims and their equivalents are intended to cover such forms or modifications as would fall within the scope and spirit of the inventions.

What is claimed is:

1. A lighting device comprising:
a cover member at least partially including a light transmitting portion and configured to have a tubular shape; and
a light source body that includes a plate-shaped and flexible substrate, the substrate being configured in such a manner that the substrate is inserted into the cover member along a longitudinal direction of the cover member, a plurality of solid state light emitting elements are disposed on one surface side of the substrate, the cross-sectional shape in a lateral direction is along an inner surface of the cover member, and on the vertical line where the plurality of solid state light emitting elements are positioned respectively, a distance between each of the adjacent solid state light emitting elements and the inner surface of the light transmitting portion is different from each other.

2. The lighting device according to claim 1,
wherein the light source body further includes a heat conducting member that supports the substrate in close contact with the other surface side of the substrate.

3. The lighting device according to claim 2,
wherein the heat conducting member is configured to have a solid and elongated shape and to be inserted into the cover member in the longitudinal direction.

4. The lighting device according to claim 2,
wherein the heat conducting member is configured to have a hollow and elongated shape and to be inserted into the cover member in the longitudinal direction.

5. The lighting device according to claim 4, further comprising:
a pair of cap members that is fixed to both ends of the cover member and the light source body in the longitudinal direction thereof and fixes a relative positional relationship between the light source body and the cover member,
wherein the cap member includes a vent hole that causes a hollow inside of the heat conducting member to communicate with an external air.

6. The lighting device according to claim 4,
wherein the heat conducting member has a light switching unit in a hollow inside thereof.

7. The lighting device according to claim 4,
wherein the heat conducting member includes a heat radiation fin or a heat radiation pin on an inner peripheral surface.

8. The lighting device according to claim 1,
wherein the substrate whose cross-sectional shape in the lateral direction is a circular shape, is configured in such a manner that the one surface side where the plurality of solid state light emitting elements are disposed forms an outside of the circular shape.

9. The lighting device according to claim 1,
wherein the substrate whose cross-sectional shape in the lateral direction is a circular arc shape, is configured in such a manner that the one surface side where the plurality of solid state light emitting elements are disposed forms an inside of the circular arc shape.

10. The lighting device according to claim 9,
wherein the heat conducting member has a cross-section of a fan-shaped semi-cylindrical body, and the substrate is supported in close contact along an inner peripheral surface of the circular arc shape of the semi-cylindrical body.

11. The lighting device according to claim 9,
wherein the substrate is configured in such a manner that a reflection rate of the one surface side where the plurality of solid state light emitting elements are disposed is equal to or greater than 80%.

12. The lighting device according to claim 1,
wherein the substrate whose cross-sectional shape in the lateral direction is a circular arc shape, is configured in such a manner that the one surface side where the plurality of solid state light emitting elements are disposed forms an outside of the circular arc shape.

13. The lighting device according to claim 12,
wherein the cover member is formed with a reflection film coated inside thereof, in a side to which the circular arc shape of the substrate is open.

14. A lighting fixture comprising:
a fixture main body; and
the lighting device according to claim 1 mounted on the fixture main body.

15. The lighting fixture according to claim 14,
wherein the fixture main body includes,
a rectangular box-shaped base portion, and
a pair of reflection plates with a substantially inverted triangular shape which is provided on a lower surface of the base portion.
